(19) United States
(12) Patent Application Publication
(10) Pub. No.: US 2021/0077338 A1
(43) Pub. Date: Mar. 18, 2021

(54) DEVICE

(71) Applicant: Crystal Clear International Limited, Liverpool (GB)

(72) Inventor: Sharon Hilditch, Liverpool (GB)

(21) Appl. No.: 17/017,823

(22) Filed: Sep. 11, 2020

(30) Foreign Application Priority Data
Sep. 13, 2019 (GB) 1913268.7

(51) Int. Cl. A61H 15/00; A61H 23/02

(52) U.S. Cl. CPC A61H 15/0085; A61H 23/0263; A61H 2201/0107; A61H 2015/0042; A61H 2205/024; A61H 2201/0153; A61H 2201/105

(57) ABSTRACT

The present invention provides a device comprising a housing assembly comprising a housing, a control means and a vibratory means; and a head assembly, wherein the housing assembly and the head assembly are separately formed and comprise complementary features that together form a releasable coupling means for coupling the housing assembly and the head assembly, wherein the vibratory means has a first vibration setting at which the vibratory means does not vibrate, a second vibration setting at which the vibratory means vibrates at between 100 and 200 Hz and a third vibration setting at which the vibratory means vibrates at between 200 and 300 Hz, and wherein the control means controls the level of vibration created by the vibratory means by switching the vibratory means between the first, second and third vibration settings.

The present application relates to a device which provides a massaging effect and may also dispense a cosmetic composition onto the skin of a user. It is particularly suited to cosmetic use, improving the appearance and health of the skin of a user and particularly of the facial areas around the eye.

There are certain known devices which massage the skin whilst dispensing a lotion or massage oil. For example, US2008014011 discloses a cosmetic dispensing device comprising a reservoir for holding a cosmetic and a motor for vibrating the device, enhancing the application of the cosmetic, as well as soothing and relaxing the skin and the underlying musculature.

US2006287616 discloses a massager comprising a massage head in which a liquid is stored and a vibratory component engaged to the massage head to provide a massage effect. US2012109041 discloses an applicator device comprising a head in which a liquid is stored and a vibratory component to provide a massage effect.

WO2008/075089 discloses a device for dispensing serum and simultaneously massaging the skin of a user. The device comprises a rotating head and a user actuated pump for dispensing serum from a reservoir housed in the device.

WO2012/038754 also discloses a device for dispensing serum and simultaneously massaging the skin of a user, which comprises a housing assembly and a head assembly. The housing assembly and the head assembly are separately formed and releasably connectable. A vibratory means in the housing assembly causes the device to vibrate, which increases the dispensation of the serum and the massaging action.

The present invention is intended to provide an improved and more versatile device for providing a massage effect to the skin of the user, which can be tailored for different desired results. The device can also be used to dispense a cosmetic composition to the skin.

In accordance with a first aspect of the present invention, there is provided a device comprising a housing assembly comprising a housing, a control means and a vibratory means; and a head assembly, wherein the housing assembly and the head assembly are separately formed and comprise complementary features that together form a releasable coupling means for coupling the housing assembly and the head assembly, wherein the vibratory means has a first vibration setting at which the vibratory means does not vibrate, a second vibration setting at which the vibratory means vibrates at between 100 and 200 Hz and a third vibration setting at which the vibratory means vibrates at between 200 and 300 Hz, and wherein the control means controls the level of vibration created by the vibratory means by switching the vibratory means between the first, second and third vibration settings

The vibratory means may comprise a motor. The motor may be a rotary motor. The motor may be an eccentric rotating mass motor.

The housing functions to both house the vibratory means and to enable the user to grip the device when in operation. The exterior surface of the housing may be smooth and/or ergonomically shaped.

The control means controls the levels of vibration created by the vibratory means by switching the vibratory means between the first vibration setting, the second vibration setting and the third vibration setting. The vibratory means may also have other vibration settings, or it may only have the first, second and third vibration settings.

The control means may be a switch of any possible construction, for example, a toggle switch, in-line switch, push-button switch, rocker switch. The part of the switch that is actuated by the user may not project from the plane of the housing, to maximise user comfort when gripping the device.

Vibrations in the frequency range of the second vibration setting have been found to gently exercise the muscles in delicate areas of skin, thereby reducing the appearance of wrinkles without causing any damage to the delicate skin. Vibrations in the frequency range of the second vibration setting can also create a lymphatic drainage effect, thereby reducing puffiness, particularly in areas such as that under the eye.

It has also been found that vibrations in the frequency range of the third vibration setting have a biomechanical activity and can be used to exercise and stimulate larger muscles. This provides a lifting effect, particularly when used on regions of a user's face such as cheeks and neck.

Additionally, vibrations in both frequency ranges are sufficient to help release a cosmetic compound from a reservoir in embodiments in which the head assembly comprises a reservoir containing a cosmetic compound.

Thus, the combination of the second and third vibration settings in the present invention means that a single device can be used to reduce the appearance of wrinkles on certain regions of skin, while lifting other regions of skin. This therefore results in a more versatile device.

“Delicate skin” as used herein refers to regions of a user's skin that are more delicate and/or sensitive than other regions of the skin. Delicate skin regions generally have thinner skin and smaller muscles than the average over the user's body. The user may be a human and such regions may include the region directly under a human's eye.

“Non-delicate skin” as used herein refers to regions of a user's skin that are not delicate, as defined above. These regions generally have at least the average skin thickness and muscle size over the user's body. Such regions include a human's cheeks, forehead and neck, as well as other body parts such as legs and buttocks.

The head assembly and the housing assembly are separately formed and are configured to be releasably coupled via the releasable coupling means. This formation of the device as two separable assemblies is particularly advantageous for several reasons.

For example, different head assemblies can be used with the same housing assembly. This also means that the different vibration settings can be used with different head assemblies, providing even more versatility in relation to the results seen. Additionally, different head assemblies can be tailored for use with one of the two different vibration settings in order to enhance the results seen.

If the head assembly contains a cosmetic composition, the head assembly may be replaced or refilled when it runs dry. This provides a significant advantage over many prior art devices which are disposed of in their entirety once they run dry. More specifically, it is envisaged that the materials and components from which the head assembly is produced will be more easily recycled or safely disposed of than those from which prior art devices are produced. For example, a number of disposable prior art devices include components such as motors, batteries, wires and other electronic components and therefore require deconstruction in order to safely be disposed of.

An additional advantage of providing the housing and head assemblies as separate parts is that the head assembly can be removed and filled with a cosmetic composition of the user's choice. Accordingly, if the user wishes to apply different types of cosmetic composition at different times, this is possible using a single device.

The vibratory means may vibrate at more than 100 Hz to less than 200 Hz in the second setting and at more than 200 Hz to less than 300 Hz in the third setting.

The vibratory means may vibrate at between 120 and 180 Hz at the second setting and between 220 and 280 Hz at a third setting. The vibratory means may vibrate at between 150 and 180 Hz at the second setting and between 220 and 250 Hz at a third setting. The vibratory means may vibrate at between 160 and 175 Hz at the second setting and between 225 and 240 Hz at a third setting. These frequencies provide a clearer distinction between the levels of vibration at each setting, as well as tailoring the vibration levels to increase the reduction of wrinkles at the second setting and increasing the lifting effect at the third setting.

These frequencies may be generated by a rotating part in the vibratory means, which may be a motor. The rotating part may rotate at between 8000 and 12000 rpm in the second setting and between 12000 and 16000 rpm in the third setting. The rotating part may rotate at between 9000 and 11000 rpm in the second setting and between 13000 and 15000 rpm in the third setting.

As discussed above, the head assembly may comprise a reservoir for a cosmetic composition. Said head assembly may further comprise at least one ball which is contactable with the skin of the user, a portion of the at least one ball being in fluid communication with the reservoir and a retainer means for rotatably retaining the at least one ball in the head assembly.

The reservoir is adapted to contain a cosmetic composition. The cosmetic composition may be a liquid, a cream or a gel. The cosmetic composition contacts the portion of the ball that is in fluid communication with the reservoir and becomes adhered thereto. When the ball is rotated within the retainer means, said adhered cosmetic composition is removed from the reservoir and can therefore be applied to the skin of the user.

The second and third vibration settings of the present invention have both been found to be particularly useful in combination with such a head assembly, as both vibration settings help the release of the cosmetic composition from the reservoir. However, the vibration frequency of the third vibration setting results in an increased amount of cosmetic composition being released from the reservoir, as vibrations in this frequency range create a whirlwind effect within the reservoir that projects an increased amount of cosmetic component out of the reservoir.

The head assembly may comprise one ball or may comprise a plurality of balls. The ball may be prepared from any material known by those skilled in the art to be suitable. In a preferred embodiment, the ball is formed of stainless steel. Each ball may rotate within a collar that extends from the reservoir towards the ball, having an open end that allows the cosmetic composition to flow from the reservoir onto a portion of the ball and subsequently out of the reservoir.

The at least one ball may be movable between an operative position where cosmetic composition will be dispensed onto the skin of a user if the at least one ball is rotated across the skin and a non-operative position where cosmetic composition will not be dispensed. This helps to prevent any of the cosmetic composition from being wasted. The at least one ball may be resiliently biased to move between the operative and non-operative positions, for example using a return spring acting on the ball.

The head assembly may alternatively comprise an elongate portion extending perpendicular to the axis along which the head assembly is attached to the housing assembly. The elongate portion therefore may extend perpendicular to the central axis of the housing assembly. The head assembly may further comprise a neck portion, which separates the elongate portion from the releasable coupling means of the head assembly. Thus, the head assembly may be a T-bar shape.

The elongate portion may have no sharp edges and instead, may have a curved surface. The elongate portion may have an oval cross-section. The central axis along the length of the elongate portion may not intersect with the central axis of the housing assembly and/or the axis along which the head assembly is attached to the housing assembly (which may be the same). The neck portion of the head assembly may be curved, which may offset the central axis of the elongate portion from the central axis of the housing assembly and/or the axis along which the head assembly is connected to the housing assembly (which may be the same).

The curved surface of the elongate portion and/or the curved neck portion help to ensure that the device can easily reach portions of the user's body, such as under the chin. This head assembly is intended to provide an increased massage effect to the skin of a user, which results in improved lifting and toning of the skin.

The elongate portion of the T-bar may be textured. The elongate portion of the T-bar may have multiple raised portions, which may be circular or oval in cross-section. The raised portions may be arranged in parallel lines extending along the length of the elongate portion. This can further increase the massage effect to the skin of a user.

The T-bar head assembly is beneficially used on delicate skin when the device is operated at the second vibration setting. For example, this head assembly is particularly effective at reducing puffiness under the eye as the gentle vibration effect increases lymphatic drainage.

This head assembly can also be used to lift and tone the skin of areas such as the neck. This is particularly effective when the device is operated at the third vibration setting.

The T-bar head assembly may be formed from a metal. The T-bar head assembly may be formed from aluminium or steel, which may be stainless steel. The coolness of the metal helps to reduce oedema, thereby further reducing puffiness and toning the skin.

The elongate portion of the T-bar head assembly may have a length of between 3 and 6 cm. This is suited for application to the face, as these dimensions correspond well to the dimensions of a user's face, ensuring that all of the skin on the face can easily be reached.

The elongate portion of the T-bar head assembly may have a length of between 6 and 12 cm. This is suited for application to the body, as these dimensions allow larger areas of skin to be contacted by the device. Thus, this head assembly can be used to reduce the appearance of cellulite, which is particularly effective when the device is operated at the third vibration setting.

The housing assembly preferably comprises an elongate housing. The housing is preferably long enough for a user to grip, as well as being long enough to contain the vibratory means. Thus, the housing, and therefore also the housing assembly, have a central axis which extends the length of the housing.

The housing will comprise a top surface at the end that comprises the releasable coupling means. This surface may simply be the circumference around the top end of the housing. The base surface of the head assembly may contact the top surface of the housing when they are connected via the releasable coupling means.

This means that the housing assembly and the head assembly are in contact both via the releasable coupling means and via the top surface of the housing. This increases the efficiency of transfer of vibrations from the vibratory means into the head assembly.

The releasable coupling means attaches the housing assembly and the head assembly. The releasable coupling means may comprise complementary press fit features, so that the head assembly can be attached to the housing assembly simply by pushing the press fit features together, and can be disengaged by pulling the press fit features apart. Alternatively, the releasable coupling means may comprise threading to enable the head assembly to be screwed into the housing assembly or vice versa.

The head assembly may comprise one or more ridge on its external surface, preferably on the external surface surrounding the releasable coupling means. The one or more ridge extends from the surface of the head assembly and is separate from the releasable coupling means. The head assembly may comprise between two and six ridges. This one or more ridge helps to direct the vibration from the vibratory means to the head assembly. The one or more ridge can also help the user grip the head assembly when attaching or detaching it from the housing assembly.

The vibratory means may be adjacent the releasable coupling means. This means that the vibratory means is close to the head assembly, thereby increasing the efficiency of the transfer of vibrations from the housing assembly to the head assembly.

The vibratory means may be separated from the housing by a damping means, which reduces the vibrations transferred to the housing during use. This can help increase the efficiency of the transfer of vibrations from the housing assembly to the head assembly.

The head assembly may further comprise a releasable O-ring attached around the outer surface of the head assembly, preferably around the circumference of the head assembly. The releasable O-ring may extend around the neck portion of the T-bar head assembly. This releasable O-ring may be arranged such that it can hold a material, such as a fabric, positioned between the O-ring and the rest of the head assembly in position. This further increases the versatility of the head assembly, as it can easily be modified with other materials, such as fabrics, by the user.

The releasable O-ring may be a flexible and resilient material, such as rubber. This makes it easier to remove and re-attach the O-ring from the head assembly, as well as allowing the O-ring to slightly expand to accommodate a material that may be present between the O-ring and the rest of the head assembly.

Thus, the head assembly may further comprise a fabric extending over at least part of the head assembly and held in position using the releasable O-ring. The fabric can therefore further modify the properties of the head assembly, for example providing a smoother or rougher surface, which can modify the amount of exfoliation provided by the device. Additionally, the fabric is removable and therefore can be used to improve the hygiene of the device.

The fabric may be impregnated with a cosmetic composition, or a cosmetic composition may be applied thereto. This cosmetic composition may be the same or different to that in the head assembly reservoir if used in combination with a head assembly that has a reservoir. This can further tailor the head assembly to the requirements of the user and can be used to vary or broaden the number of cosmetic compositions applied to the skin.

The cosmetic composition may be an exfoliant, a serum or a moisturiser. The cosmetic composition impregnated into the fabric may be an exfoliant, which greatly increases the exfoliation properties of the device.

The housing may house a power source, such as a battery, which powers the vibratory means. The vibratory means may be rechargeable, preferably from a mains power supply.

The vibratory means may be operated by a voltage in the range of about 3 to about 5 volts. The voltage may be different when the vibratory means is operated in the second and third vibration settings. The voltage at the second vibration setting may be between 3 and 4 volts, while the voltage at the third vibration setting may be between 4 and 5 volts.

The device may further comprise a cap. The cap may be releasably coupled to the head assembly, for example via a press fit or snap fit coupling, or in a threaded arrangement.

According to a second aspect of the present invention, there is provided a kit comprising a housing assembly comprising a housing, a control switch and a vibratory means; a head assembly comprising a reservoir and at least one ball which is contactable with the skin of the user, a portion of the at least one ball being in fluid communication with the reservoir and a retainer means for rotatably retaining the at least one ball in the head assembly; and a head assembly comprising an elongate portion extending perpendicular to the axis along which the head assembly is attached to the housing assembly wherein the housing assembly and the head assemblies are separately formed and comprise complementary features that together form a releasable coupling means for coupling the housing assembly and each of the head assemblies, wherein the vibratory means has a first vibration setting at which the vibratory means does not vibrate, a second vibration setting at which the vibratory means vibrates at between 100 and 200 Hz and a third vibration setting at which the vibratory means vibrates at between 200 and 300 Hz, and wherein the control means controls the level of vibration created by the vibratory means by switching the vibratory means between the first, second and third vibration settings.

The kit of the present invention allows the user to select the head assembly and the vibration setting as desired, depending on the issue to be addressed and region of skin on which the device is to be used. Thus, this kit improves the versatility of the device.

The kit may further comprise a fabric, as discussed above in relation to the first aspect of the invention. The fabric may be impregnated with a cosmetic composition, as discussed above. The kit may comprise a plurality of such fabrics. Said plurality of fabrics may be impregnated with the same or with different cosmetic compositions.

The kit may further comprise a cosmetic composition. The kit may further comprise a plurality of cosmetic compositions. The cosmetic composition may be for inclusion in the head assembly reservoir and/or for impregnation into or application onto the fabric if included in the kit. This therefore further increases the versatility of the device.

According to a third aspect of the present invention, there is provided a method of cosmetically treating the skin of a user comprising applying the device of the invention when vibrating at the second vibration setting to a first portion of the skin; and applying the device of the invention when vibrating at the third vibration setting to a second portion of the skin.

This method allows the user to create different target results on different regions of skin, depending on the sensitivity of the skin and the issue to be targeted.

The first portion of skin may be delicate skin and the second portion of skin may be non-delicate skin. The first portion of skin may be a portion containing wrinkles and the second portion of skin may be a portion requiring a lifting effect. Thus, this method allows delicate or sensitive skin to be cosmetically treated as well as other, non-delicate regions of the skin, using a single device.

The delicate portion of the skin may be the portion directly under the eye of the user. The non-delicate portion of the skin may be at least part of the rest of the user's face. The non-delicate portion of the skin may be a part of the user's body other than the face.

Thus, the method of the invention can create an improved effect on a user's face, as different regions of skin that have different cosmetic issues can be targeted using a single device. This ensures that the muscles in the face get the lifting they require, without damaging the more delicate regions of the face.

For the avoidance of any doubt, where reference is made to the features of the head assembly of the device of the above first aspect of the present invention, those features are equally applicable to the kit of the second aspect of the present invention or the method if the third aspect of the present invention.

A specific embodiment of the present invention will now be described, by way of example only, with reference to the accompanying drawings in which:

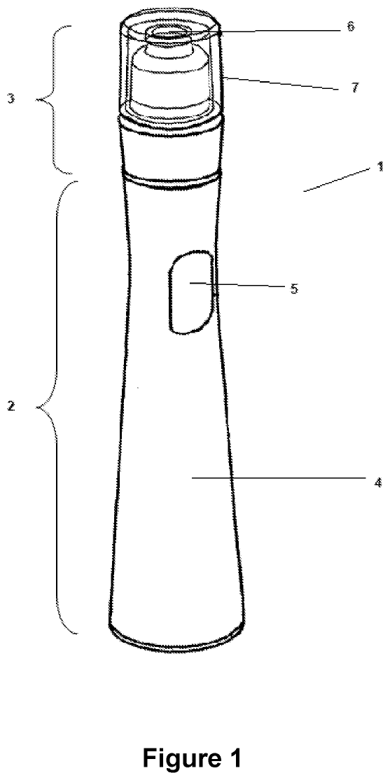

FIG. 1 shows a perspective view of a device according to the first aspect of the present invention;

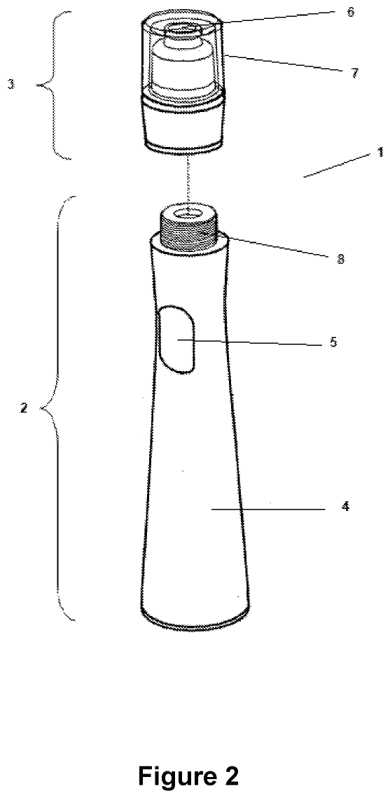

FIG. 2 shows a perspective view of the device of FIG. 1 where the head assembly and the housing assembly have been separated;

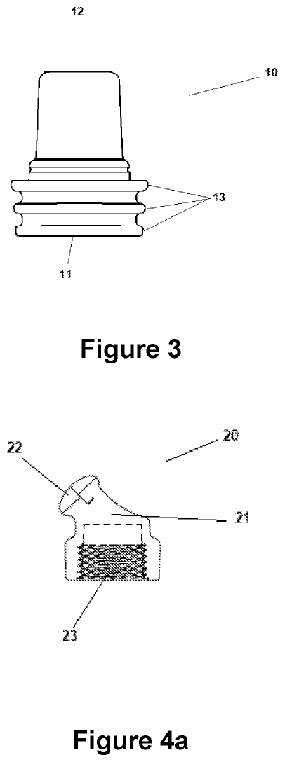

FIG. 3 shows a front plan view of a head assembly according to a first embodiment of the present invention;

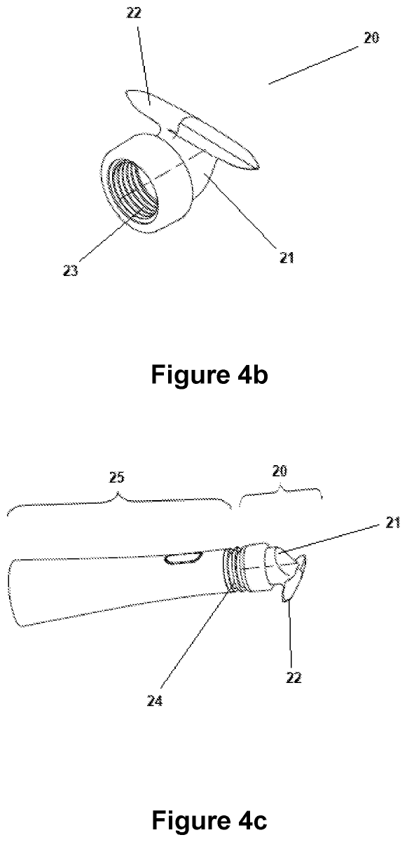

FIG. 4a shows a side plan view of a head assembly according to a second embodiment of the present invention;

FIG. 4b shows a perspective view of the head assembly of FIG. 4a; and

FIG. 4c shows a perspective view of the head assembly of FIG. 4a in combination with a housing assembly.

FIGS. 1 and 2 show a combined massage and cosmetic composition dispensing device 1. It is particularly, but not exclusively, suited to treatment of facial areas.

The device 1 has an elongate housing assembly 2 which is shaped and proportioned to permit it to be comfortably handheld. The housing assembly 2 comprises a housing 4 and a control means 5. The vibratory means is positioned within the housing 4 but is not shown in these figures. Towards one end, the housing 4 broadens to form a base and at the other end it is coupled to a head assembly 3.

The head assembly 3 forms a reservoir for the cosmetic composition and comprises a ball 6 which is rolled across the user's skin to dispense cosmetic composition.

The control means 5 comprises a press switch which, when depressed by the user, changes the level of vibration produced by the vibratory means. Depressing the switch once means that the vibratory means vibrates at the second vibration setting, at a frequency of between 100 and 200 Hz. Depressing the switch again means that the vibratory means vibrates at the third vibration setting, at a frequency of between 200 and 300 Hz. Depressing the switch for a third time stops the vibratory means vibrating.

The head assembly 3 is also provided with a cap 7. The cap 7 is releasably coupled to the head assembly 3 by an inwardly protruding flange which is received by a complementary groove formed in the head assembly 3.

The cap 7 is formed of a clear material which is sufficiently flexible such that the circumference of the region of the cap where the flange is formed can be transiently expanded to enable the cap 7 to be removed from the head assembly 3 by the user.

As shown in FIG. 2, the head assembly 3 is releasably coupled to the housing assembly 2 via complementary threaded portions 8 in the head assembly 3 and the housing 4 of the housing assembly 2. These threaded portions 8 together form the releasable coupling means of the device.

FIG. 3 illustrates a head assembly 10 according to one embodiment of the present invention. The head assembly 10 comprises an upper surface 12 in which the ball will be positioned and a lower surface 11 which will contain the releasable coupling means required to attach the head assembly 10 to a housing assembly.

The head assembly 10 further comprises three ridges 13 on the external surface of the head assembly 10, surrounding the releasable coupling means. The ridges 13 help to direct the vibrations from the vibratory means towards the upper surface 12 of the head assembly and away from the housing assembly, when the device is in use. The ridges 13 can also help the user grip the head assembly 10 when attaching or detaching it from the housing assembly.

FIGS. 4a and 4b illustrate an alternative head assembly 20 to that disclosed in FIG. 3. This head assembly 20 is in a T-bar shape, comprising a neck portion 21 and an elongate portion 22 extending perpendicular to the direction in which the head assembly is attached to the housing assembly. The head assembly 20 is formed from aluminium.

The head assembly 20 also comprises a threaded portion 23, which is used to connect the head assembly 20 to a housing assembly. The long central axis of the elongate portion 22 does not intersect the central axis of the threaded portion 23 and therefore does not intersect the central axis of the housing assembly when the head assembly 20 is connected thereto, or the axis along which the head assembly 20 is attached to the housing assembly.

The elongate portion 22 has an oval cross-section and does not contain any sharp edges. Instead, the elongate portion 22 is curved, thereby making it more comfortable for the user and allowing the elongate portion 22 to fit into the contours of the user's body, such as the neck.

FIG. 4c illustrates the head assembly 20 connected to a housing assembly 25. The head assembly 20 in this figure further comprises three ridges 24. As with the head assembly in FIG. 3, these ridges help to direct the vibrations into the head assembly and away from the housing assembly and can also help the user grip the head assembly 20 when attaching or detaching it from the housing assembly 25.

As can be seen from this figure, the central axis of the housing assembly 25, which extends along the length of the housing from the base to the releasable coupling means, does not intersect with the central axis of the elongate portion 22, due to the curvature of the neck portion 21.

### EXAMPLE 1

A device as shown in FIG. 1 was run at a frequency of 167 Hz (i.e. the second vibration setting) and at 233 Hz (i.e. the third vibration setting) while the reservoir was full of the same amount of the same serum. The amount of serum released onto a surface when the rollerball was run continuously over the surface for 10 cm at each setting was measured.

It was found that significantly more serum was released at the third vibration setting than at the second vibration setting.

### EXAMPLE 2

The lifting effect created by a device as shown in FIG. 1 was tested. The device was applied to one cheek of a user for 10 seconds while running at a frequency of 167 Hz (i.e. the second vibration setting) and to the other cheek of the user for 10 seconds while running at a frequency of 233 Hz (i.e. the third vibration setting).

A visual comparison of the two cheeks was made. The muscles of the cheek treated at the third vibration setting were noticeably more lifted than those of the cheek treated at the second vibration setting.

### EXAMPLE 3

The effect of the device shown in FIG. 1 was tested over 8 weeks on 30 individuals, using cutometry and profilometry tests, as well as digital photography. Each individual used the device on the periorbital area and cheek on one side of their face at the second vibration setting (183 Hz). This side is the treated side, while the opposite side of the face provides the untreated measurements.

Replicas of the skin profile in the test region were made using a Silflo® material. Each replica was illuminated with a collimated light source directed at a 25° angle from the plane of the replica and then analysed using profilometric software.

The luminance was measured along a set of 10 equal length parallel lines running across the replica parallel to the lighting direction. Variations in luminance were treated as being indicative of the roughness and analysed using traditional surface roughness statistics. The average maximum difference in luminance value for five equal length segments in each of the 10 lines was calculated (Rz) and the results are shown in Table 1.

TABLE 1

| | Pre-treatment | 1 Hour | 8 Weeks |
|---|---|---|---|
| Untreated | 123.1 | 123.0 | 123.1 |
| Treated | 123.0 | 118.8 | 88.9 |

These results showed a statistically significant reduction (p<0.001) in fine lines and wrinkles. Fine lines were reduced by an average of 3.42% after one hour of treatment and by 27.7% after 8 weeks of treatment. On untreated sites, fine lines increased by an average of 0.03% over 8 weeks.

Skin viscoelasticity was also tested using a Cutometer, based on the suction method. Negative pressure was created in the device and the skin was drawn into the aperture of a probe. The penetration depth of the skin within the probe was detected by a non-contact optical measuring system. The resistance of the skin to being sucked up by the negative pressure (firmness) and its ability to return to its original position (elasticity) were measured. These were used to calculate the viscoelasticity of the skin as delayed distention over immediate distention (Uv/Ue) and the results are shown in Table 1.

TABLE 2

| | Pre-treatment | 1 Hour | 8 Weeks |
|---|---|---|---|
| Untreated | 0.518 | 0.518 | 0.518 |
| Treated | 0.518 | 0.560 | 0.755 |

As shown in this table, the skin viscoelasticity was statistically significantly improved (p<0.001), as the skin was firmed by 7.98% after one hour of treatment and 45.67% after 8 weeks of treatment. On untreated sites, the viscoelasticity did not significantly change.

1. A device comprising:
a housing assembly comprising a housing, a control means and a vibratory means; and
a head assembly
wherein the housing assembly and the head assembly are separately formed and comprise complementary features that together form a releasable coupling means for coupling the housing assembly and the head assembly,
wherein the vibratory means has a first vibration setting at which the vibratory means does not vibrate, a second vibration setting at which the vibratory means vibrates at between 100 and 200 Hz and a third vibration setting at which the vibratory means vibrates at between 200 and 300 Hz, and
wherein the control means controls the level of vibration created by the vibratory means by switching the vibratory means between the first, second and third vibration settings.

2. The device of claim 1, wherein the vibratory means vibrates at between 150 and 180 Hz at the second vibration setting and vibrates at between 220 and 250 Hz at the third setting.

3. The device of claim 1, wherein the head assembly comprises a reservoir and at least one ball which is contactable with the skin of the user, a portion of the at least one ball being in fluid communication with the reservoir and a retainer means for rotatably retaining the at least one ball in the head assembly.

4. The device of claim 1, wherein the head assembly comprises an elongate portion extending perpendicular to the axis along which the head assembly is attached to the housing assembly and/or extending perpendicular to the central axis of the housing assembly.

5. The device of claim 4, wherein the head assembly is formed from metal, preferably aluminium or steel.

6. The device of claim 4, wherein the elongate portion has a length of between 3 and 6 cm.

7. The device of claim 4, wherein the elongate portion has a length of between 6 and 12 cm.

8. The device of claim 1, wherein a base surface of the head assembly contacts a top surface of the housing when they are connected via the releasable coupling means.

9. The device of claim 1, wherein the head assembly comprises one or more ridge on the external surface of the head assembly surrounding the releasable coupling means.

10. The device of claim 1, wherein the vibratory means is adjacent the releasable coupling means.

11. The device claim 1, wherein the head assembly comprises a releasable O-ring attached around the outer surface of the head assembly.

12. The device of claim 11, further comprising a fabric extending over at least part of the head assembly and held in position using the releasable O-ring.

13. The device of claim 12, wherein the fabric is impregnated with a cosmetic composition, optionally wherein the cosmetic composition is an exfoliant.

14. The device of claim 1, wherein the vibratory means is rechargeable.

15. A kit comprising:
a housing assembly comprising a housing, a control switch and a vibratory means;
a head assembly comprising a reservoir and at least one ball which is contactable with the skin of the user, a portion of the at least one ball being in fluid communication with the reservoir and a retainer means for rotatably retaining the at least one ball in the head assembly; and
a head assembly comprising an elongate portion extending perpendicular to the axis along which the head assembly is attached to the housing assembly
wherein the housing assembly and the head assemblies are separately formed and comprise complementary features that together form a releasable coupling means for coupling the housing assembly and each of the head assemblies,
wherein the vibratory means has a first vibration setting at which the vibratory means does not vibrate, a second vibration setting at which the vibratory means vibrates at between 100 and 200 Hz and a third vibration setting at which the vibratory means vibrates at between 200 and 300 Hz, and
wherein the control means controls the level of vibration created by the vibratory means by switching the vibratory means between the first, second and third vibration settings.

16. The kit of claim 15, further comprising a fabric that can be impregnated with a cosmetic composition, optionally wherein the fabric is impregnated with a cosmetic composition.

17. The kit of claim 15, further comprising a cosmetic composition.

18. A method of cosmetically treating the skin of a user comprising:
applying the device of claim 1 when vibrating at the second vibration setting to a first portion of the skin; and
applying the device when vibrating at the third vibration setting to a second portion of the skin.

19. The method of claim 18 wherein the first portion of the skin is the portion directly under the eye of the user and the second portion of the skin is at least part of the rest of the user's face.
